(19) United States
(12) Patent Application Publication
(10) Pub. No.: US 2021/0217151 A1
(43) Pub. Date: Jul. 15, 2021

(54) NEURAL NETWORK TRAINED SYSTEM FOR PRODUCING LOW DYNAMIC RANGE IMAGES FROM WIDE DYNAMIC RANGE IMAGES

(71) Applicant: ToneTech Inc., Calgary (CA)

(72) Inventors: Orly Yadid-Pecht, Calgary (CA); Jie Yang, Calgary (CA)

(21) Appl. No.: 17/272,170

(22) PCT Filed: Aug. 29, 2019
(86) PCT No.: PCT/CA2019/051196

§ 371 Date: Feb. 26, 2021

Related U.S. Application Data
(60) Provisional application No. 62/724,549, filed on Aug. 29, 2018.

(51) Int. Cl. G06T 5/00; G06T 5/50; G06N 3/08; G06N 3/04

(52) U.S. Cl. CPC G06T 5/009; G06T 5/50; G06T 2207/20081; G06N 3/0481; G06T 2207/20084; G06N 3/08

(57) ABSTRACT

Systems and methods for providing low dynamic range images from wide dynamic range images. A wide dynamic range image is first converted into a normalized image and is decomposed into a multiple Laplacian images and each of the Laplacian images is passed through one level of the process. Each level of the process has multiple sets of processing layers and produces a transition image. The various transition images form a decomposed Laplacian pyramid of the normalized image and a reconstructed image from the various Laplacian images is the low dynamic range image. Each level of the process is constructed as a neural network whose relevant filters, weights, and biases are determined by training the neural network using manually selected input and output images.

### TECHNICAL FIELD

The present invention relates to image processing. More specifically, the present invention relates to methods and systems for producing a low dynamic range image from a wide dynamic range image.

### BACKGROUND OF THE INVENTION

The dynamic range of a scene, image, or device is defined as the ratio of the intensity of the brightest point to the intensity of the darkest point. For natural scenes, this ratio can be in the order of millions. Wide dynamic range images, also called high dynamic range (HDR) images, are images that exhibit a large dynamic range. To better capture and reproduce the wide dynamic range in the real world, WDR images were introduced. To create a WDR image, several shots of the same scene at different exposures can be taken, and dedicated software can be used to create a WDR image.

Currently, sophisticated multiple exposure fusion techniques can be used to construct WDR images. As well, many available CMOS sensors already embed WDR or HDR capabilities, and some recent digital cameras have embedded, within the camera, functionality to automatically generate WDR images. However, most of today's display devices (such as printers, CRT and LCD monitors, and projectors) have a limited or low dynamic range. As a result of this, the captured scene of a WDR image on such display devices will either be over-exposed in the brighter or lit areas or under-exposed in the darker areas. This causes details within the scene or image to be lost. Thus, there is a need to compress the dynamic range of a WDR image to the standard low dynamic range of today's display devices. Tone mapping algorithms currently perform this compression/adaptation of the dynamic range.

### SUMMARY OF INVENTION

The present invention provides systems and methods for providing low dynamic range images from wide dynamic range images. A wide dynamic range image is first converted into a normalized image and is decomposed into a multiple Laplacian images and each of the Laplacian images is passed through one level of the process. Each level of the process has multiple sets of processing layers and produces a transition image. The various transition images form a decomposed Laplacian pyramid of the normalized image and a reconstructed image from the various Laplacian images is called coarse low dynamic range image. The final low dynamic range image is generated from the coarse low dynamic range image with an additional level of the process. Each level of the process is constructed as a neural network whose relevant filters, weights, and biases are determined by training the neural network using manually selected input and output images.

It should be clear that the present invention relates to a method for converting wide dynamic range (WDR) images to low dynamic range (LDR) images using Laplacian pyramid decomposition and deep convolutional neural networks (DCNN). The DCNN is trained off-line with a dedicated WDR image database. The tone mapping method takes advantage of the abstraction ability of DCNN and can map the WDR image to an LDR image with good computational efficiency.

In one aspect, the present invention provides a method for producing a low dynamic range image from a wide dynamic range image, the method comprising:
a) producing a normalized image of said wide dynamic range image;
b) decomposing said normalized image into multiple Laplacian images;
c) passing each of said multiple Laplacian images through a different level of sets of processing layers, each level of sets of processing layers producing a transition image to result in a plurality of transition images;
d) reconstructing a coarse low dynamic range image from said plurality of transition images;
e) generating a final low dynamic range image from the said coarse low dynamic range image through an addition layer of process.
   wherein each level of sets of processing layers comprises at least three layers of processing layers, said at least three layers of processing layers comprising:
a first processing layer for detecting large gradients from input data;
a second processing layer for compressing large gradients detected by said first processing layer and enhancing small gradients; and
a third processing layer for reconstructing said transition image.

In another aspect, the present invention provides a system for producing a low dynamic range image from a wide dynamic range image, the system comprising:
at least one data processor configured for:
   producing a normalized image of said wide dynamic range image;
   decomposing said normalized image into multiple Laplacian images;
   passing each of said Laplacian images through a different level of sets of processing layers, each level of sets of processing layers producing a transition image;
   combining transition images produced by each level of sets of processing layers to produce a coarse low dynamic range image;
   generating the final low dynamic range image from the said coarse low dynamic range image; and
   a database of training wide dynamic range images and corresponding training low dynamic range images, said training wide dynamic range images and corresponding training low dynamic range images being for use in determining parameters for said levels of sets of processing layers;

wherein
each level of sets of processing layers is implemented as processor readable and executable instructions for:
detecting large gradients from input data;
compressing detected large gradients and enhancing small gradients; and
reconstructing a transition image from said gradients.

In a further aspect, the present invention provides a method for processing a wide dynamic range image to result in a low dynamic range image, the method comprising:

a) producing a normalized image from said wide dynamic range image and decomposing said normalized image into multiple Laplacian images;

b) processing each of said multiple Laplacian images to detect large gradients from input data;

c) processing a result of step b) to compress large gradients and to enhance small gradients;

d) processing a result of step c) to generate a transition image;

e) processing the transition images of step d) to generate a coarse low dynamic range image;

f) processing the coarse low dynamic range image from step e) to generate a final low dynamic range image;

wherein at least one of steps b)-d) and f) is accomplished by way of a convolutional neural network.

In yet another aspect, the present invention provides computer readable media having encoded thereon computer readable and computer executable instructions that, when executed, implements a method for producing a low dynamic range image from a wide dynamic range image, the method comprising:

a) producing a normalized image of said wide dynamic range image;

b) decomposing said normalized image into multiple Laplacian images;

c) passing each of said multiple Laplacian images through a different level of sets of processing layers, each level of sets of processing layers producing a transition image to result in a plurality of transition images;

d) reconstructing a coarse low dynamic range image from said plurality of transition images;

f) generating a final low dynamic range image from said coarse low dynamic range image;

wherein each level of sets of processing layers comprises at least three layers of processing layers, said at least three layers of processing layers comprising:
a first processing layer for detecting large gradients from input data;
a second processing layer for compressing large gradients detected by said first processing layer and enhancing small gradients; and
a third processing layer for reconstructing said transition image.

In another aspect of the invention, there is provided a method for processing a wide dynamic range image to result in a low dynamic range image, the method comprising:

a) producing a normalized image from said wide dynamic range image and decomposing said normalized image into n multiple Laplacian images, said multiple Laplacian images including a last decomposed image layer lₙ;

b) except for said last decomposed image layer, processing each of said multiple Laplacian images to produce a high frequency image l_{high} containing high frequency signals of said wide dynamic range image;

c) processing said high frequency image using a neural network to produce a first transition image m_{high};

d) processing said last decomposed image layer using a neural network to produce a second transition image m_{low};

e) processing said second transition image to produce a final transition image m₁;

f) combining said first transition image and said final transition image to produce said low dynamic range image.

### BRIEF DESCRIPTION OF THE DRAWINGS

The embodiments of the present invention will now be described by reference to the following figures, in which identical reference numerals in different figures indicate identical elements and in which:

FIG. 1 is a schematic block diagram of one aspect of the present invention;

FIG. 2 schematically illustrates an operation for one level of a network using the architecture illustrated in FIG. 1;

FIG. 3 is a schematic block diagram of an nth level of sets of processing layers as detailed in FIG. 1;

FIG. 4 is a block diagram illustrating another aspect of the present invention; and

FIG. 5 is a schematic block diagram explaining the process illustrated in FIG. 4.

### DETAILED DESCRIPTION

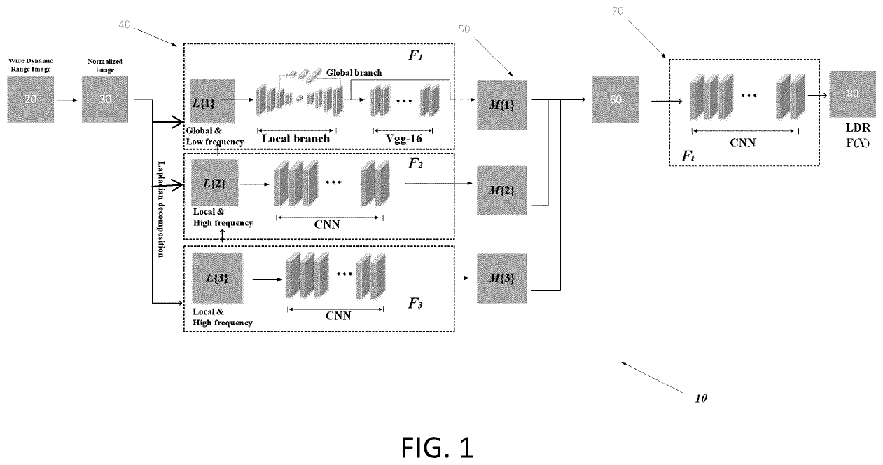

Referring to FIG. 1, a schematic diagram of a system according to one aspect of the invention is illustrated. In this system 10, a wide dynamic range image 20 is converted into a normalized image 30, and this normalized image is decomposed into an n level Laplacian pyramid. Each level of the Laplacian pyramid serves as input into a specific level 40 of the system. At each level, this decomposition (L{n}) of the normalized image 30 is passed through that level's sets of processing layers to produce a transition image 50. The output of this level 40 is then used, along with the transition images from the other various levels, to produce the coarse LDR image 60. The coarse LDR image 60 is then used to produce the final LDR 80 through the fine tone neural network 70.

It should clear that the second level produces a second transition image and that the third level of sets of processing layers produces a third transition image.

It should be clear that the various transition images produced by the various levels of sets of processing layers form a Laplacian pyramid L which is a decomposition of the original normalized image 30. The transition images (forming a Laplacian pyramid) can then be used to recover a recovered coarse LDR image 60. This generated image 80 from image 60 is the desired low dynamic range image produced from the original wide dynamic range image 20.

In addition to the above, it should also be clear that there may be multiple levels of sets of processing layers and not just the levels illustrated in FIG. 1. As well, it should be clear that there may be multiple sets of processing layers per level. Thus, to produce the first transition image 50, multiple layers may be used and, to produce the coarse LDR image 60, multiple levels (i.e. more than the 3 illustrated) may be used.

It should also be clear that normalization of the input WDR image is well-known.

As an example, the 1% of the highest and lowest pixel values in an input image can be clipped and the rest of the pixel values can be normalized to be between 0 and 1. Thus, for this example, the pixel values of the WDR image can be any value as long as they are between 0 and 1.

The system in FIG. 1 can thus be seen as an end to end processing flow. The input WDR image can be denoted as X. The goal is to produce, from X, a low dynamic image F(X) that preserves as much detail and contrast as possible. The input to the processing flow is the normalized image I. This normalized image is decomposed into an n level Laplacian pyramid L, where each level is a Laplacian image denoted as L{n} where n is the number of level. Thus, L{n} is the nth transition image produced by level n of sets of processing layers. Generally speaking, n is a parameter of the system and, preferably, n is equal to 3 or 4 as larger n values indicate more levels and thus more computation. A choice of n equalling to 3 or 4 can give a good tone mapped image and it provides a good balance between computation and performance.

For clarity, in each level, there will be a neural network that takes L{n} as input and outputs an image M{n}. All M{n} images (i.e. transition images) compose a Laplacian pyramid M. The recovered image of the M is the coarse low dynamic range image 60.

The final output low dynamic range image F(y) is generated with the coarse low dynamic range image.

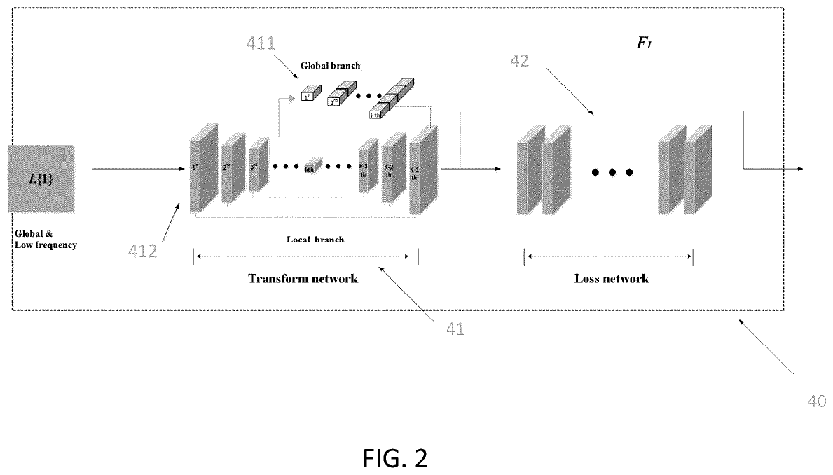

To better explain the processing occurring in the first layer, FIG. 2 is provided. FIG. 2 illustrates two sub-networks, a transformation network 41 and a loss network 42. The transformation network 41 contains global branch 411 and local branch 412. The local branch contains k convolutional layers and k-1 deconvolution layers. The k convolutional layers and the k-1 deconvolution layers construct an encode-decode structure to parse the local information of the image. The global branch 411 is generated from the i-th convolutional layer of the local branch 412. The global branch 411 has j fully connected layers. The j-th layer of global branch 411 and the k-ith deconvolution layer are fused to generate the transition image 50 shown schematically in FIG. 1. The loss network 42 is used to generate loss of this layer.

The loss network 42 is used to compare the perceptual loss between the generated transition image and the ground truth transition image. In one implementation, the loss network 42 is a pre-trained network such as the well-known AlexNet, vgg-16, and vgg-19 networks. The use of the loss network is noted later.

For clarity, FIG. 2 illustrates one embodiment of the first layer architecture. Other embodiments may be generated by altering or removing portions of the architecture to ensure that the resulting system has a similar functionality to the embodiment illustrated in FIG. 2.

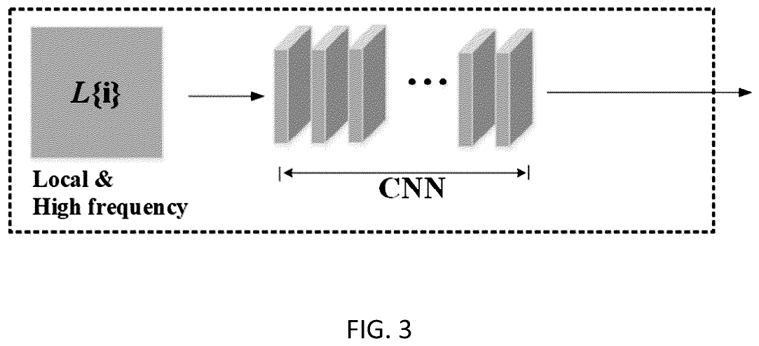

To better explain the processing occurring in the remaining layers, FIG. 3 is provided. FIG. 3 shows the j-th processing layer that takes the L{i} image as an input and outputs the M{i} transition image. This processing layer contains h convolutional layers. For clarity, the architecture of the j-th processing layer illustrated in FIG. 3 is one embodiment of the present invention. Other architectures and forms may be used as necessary (including the architecture of the first layer described in relation to FIG. 2) to result in a layer that functions similarly to and produces the same output as that illustrated in FIG. 3.

To train the neural network, a database of wide dynamic range training images (as input) and low dynamic range training images (as output) derived from the wide dynamic range training images can be used. These input and output images can be manually selected by a user to ensure that the neural network is trained to result in visually pleasing or visually appealing output images. In other words, training can be explained as, a WDR image X, the corresponding output image Y is selected from the best result of (Yᵢ¹ Yᵢ² Yᵢ³ . . . Yᵢ^{N}) where Yᵢ^{k} is a tone mapped result using a specific tone mapping algorithm or software. Yᵢ is also called as ground truth image. The Laplacian pyramid L and M can then be generated from the Xᵢ and Yᵢ correspondingly. The training images in the database can be manually selected with the LDR images being selected for high brightness and high contrast to ensure that the resulting recovered Laplacian images are visually appealing images.

To determine the proper weighting of the various filters and biases and functions, the neural network is trained in two stages. Firstly, the input WDR image will be decomposed to a Laplacian pyramid L. The ground truth image will then be decomposed to a Laplacian pyramid M′. Each layer of processing will be trained by comparing the result transition image M{i} against the ground truth image M′{i}. This is done by minimizing the loss function.

The next step is to use the neural network that receives L{1} as input and that outputs transition image M{1}. The loss function is defined by the loss network 42. For this loss network, the loss network 42 is denoted as ∅-let ∅ⱼ(x) be the activation of j-th layer of ∅ when processing input x. If ∅ⱼ(x) is of shape Cⱼ×Hⱼ×Wⱼ, then the following defines perceptual difference at layer j of loss network ∅:

$${loss}_{∅ , j} ( \hat{y} , y ) = \frac{1}{{C}_{j} \times {H}_{j} \times {W}_{j}} ‖ {∅}_{j} ( \hat{y} ) - {∅}_{j} ( y ) ‖$$

In the above equation, ŷ is the output of transform network 41, and y is the ground truth image M′{1}. The perceptual loss is defined as:

$${l}_{perceptural} = \sum {loss}_{∅ , i} ( \hat{y} , y )$$

$$i ∈ Ω$$

where Ω is the set of selected layers from loss network 42. The training of the first layer of processing can be described using the following:

$${W}_{1}^{*} = {argmin E}_{x , \{ {y}_{i} \}} {\sum }_{i = 1} {l}_{perceptural} ( {F}_{1} ( L \{ 1 \} ) , {M}^{′} \{ 1 \} )$$

For other layers of processing the takes L{i} as input and outputs M{i}, the Mean

Squared Error (MSE) equation can be used as the loss function:

$${l}_{per \text{-} pixel} ( \hat{y} , y ) = \frac{1}{CHW} ‖ \hat{y} , y ‖$$

where C, H, W are the shapes of ŷ and y. During training, ŷ is the output of the transform network and y is the ground truth image M′{i}. The training of the first layer of processing can be described using the following:

$${W}_{i}^{*} = {argmin E}_{x , \{ {y}_{i} \}} {\sum }_{i = 1} {l}_{per \text{-} pixel} ( {F}_{i} ( L \{ i \} ) , {M}^{′} \{ i \} )$$

For clarity, the above only demonstrates one possible embodiment of the loss functions for different layers. Other loss functions may be used and one can alter the loss function based on needs. For example, the first layer can use the MSE loss function and the remaining layers can use the perceptual loss function.

To find the correct network parameters for the neural network, backpropagation can be used. After the architecture of the neural network has been established and the objective function has been determined, backpropagation and training can then proceed. As is well-known, backpropagation calculates the error contribution of each neuron in the neural network. The weights and parameters for each neuron in the neural network can then be adjusted, if necessary.

After the parameters of the processing layers have been correctly found, the generated Laplacian pyramids M can form the coarse low dynamic range image. The neural network 70 will generate the final result 80 from the coarse low dynamic range image 60. The loss function can be the described MSE or perceptual loss function.

After training, the resulting system can produce LDR images from a corresponding WDR input image. The procedure is straightforward and is detailed by the equation:

Tone image of Xᵢ=Fₜ(F¹(L{1}; Θ), F²(L{2}; Θ) . . . F^{N}(L{n}; Θ))

where L{i} is the ith Laplacian image of Yᵢ.

It should be clear that although the implementation described above and the system illustrated in the Figures show three levels of sets of processing layers, this only represents a minimum. More levels of sets of processing layers may be used depending on the desired end result as well as the implementation of the present invention.

To implement the system of the present invention, one or more data processors can be configured to execute specific software modules. These modules can correspond to the various sets of processing layers within a level. Depending on the configuration of the system, each level may be implemented with its own sets of modules with different modules corresponding to the different sets or layers noted above. As an example, each layer may be implemented using multiple, differently configured modules such that the three sets for each level can be implemented using three different sets of differently configured modules. Thus, in one configuration, for a three level implementation, nine different sets of modules may be used. These various sets of modules may be executed by one or more data processors (whether virtual or actual processors). The data processors may also be executing the various modules serially or in parallel with one another.

In another implementation, the system may be configured to reuse modules. Thus, for a first level, three sets of modules may be used, each set corresponding to one of the convolution layers in the level. Once the result of the first level has been obtained, this result can then be saved and then the input to the second level can be fed back to the first set of modules (perhaps with different parameters, biases, or weights) such that the effect is the same as that of implementing a second level or set of processing layers. The result of this second pass through the modules can then be saved and the input to the third level can fed, again, into the different sets of modules (again perhaps with different parameters, weights, and biases) such that the effect is the same as implementing a third level of sets of processing layers. Thus, instead of having three different and independent groups of sets of modules (i.e. one group of three sets of modules per level with there being three levels), a single group of three sets of modules can be used. The relevant input data can then be run through the three sets of modules at different times and with different parameters to result in three different transition images.

It should be clear that the present invention may be used in different contexts. As examples, the present invention may be used for security monitoring, photography and consumer electronics. For example, Android and iOS applications can be used for tone mapping wide dynamic scenes in daily life. The present invention is especially useful for security-critical facial recognition applications because the tone mapped images have high contrast and high brightness.

It should also be clear that, once the neural network has been trained and once the relevant filters, weights, biases, and functions have been determined, the resulting processing path for each level can be replicated and implemented as a deterministic subsystem. Thus, the neural network character of the present system would be used to find the proper functions and filters necessary to result in the desired LDR image for a given WDR image. The resulting system can be re-implemented without a neural network such that any given WDR image as input would result in a desired LDR image.

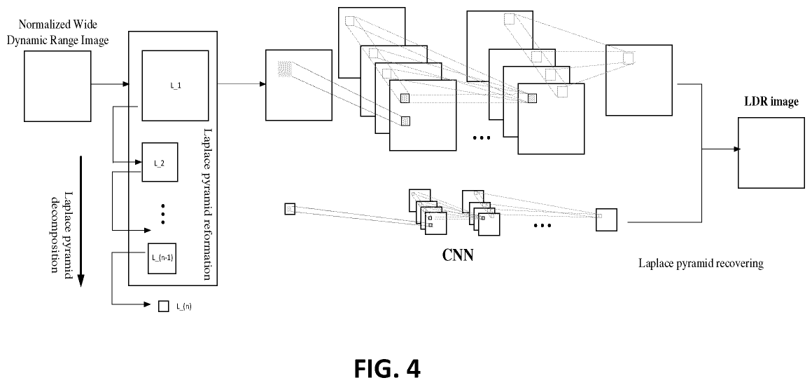

Referring to FIG. 4, another embodiment of the present invention is illustrated. In the above embodiment, Laplacian decomposition is used to decompose the original WDR image into multiple layers l₁, l₂, . . . lₙ, with each layer being processed by a dedicated neural network. This embodiment explained above uses n distinct neural networks to finish the processing. For some cases where computational memory or computational power is limited, implementing n neural networks can be a great challenge. Accordingly, in another embodiment, the complexity of the system is minimized. This other embodiment is shown in FIG. 4. As in the previous embodiment, Laplacian decomposition is used to first decompose the original WDR image into n layers denoted as l₁, l₂, . . . lₙ where l₁ is the first decomposed layer and has the same resolution as the original image. Accordingly, lₙ is the last decomposed layer image and its resolution is

$$\frac{1}{{2}^{n - 1}}$$

of the resolution of the original WDR image. The l₁, l₂, . . . l₍ₙ₁₎ layers are further reconstructed to the high frequency image l_{high} which contains high frequency signals of the original WDR image. The reconstruction is formulated by the following equation (A):

$$\{ \begin{matrix}{g}_{n - 1} = {l}_{n - 1} \\ {g}_{k} = {l}_{k} + {g}_{k + 1}^{′} if 0 < k < n - 1\end{matrix} \qquad ( A )$$

In this equation, g′ₖ₊₁ is the up-sampled version of gₖ₊₁. It should be clear that l_{high} is equal to g₁. The reconstructed l_{high} will have the same resolution as the original image.

It should be clear that, by this point in the process, the WDR image has been decomposed into lₙ and l_{high}. The image lₙ can be renamed or relabelled as l_{low}. Two convolutional neural networks l_{high} and l_{low} will be trained to transform l_{high} and l_{low} to the transition images m_{high} and m_{low}. These transition images m_{high} and m_{low} are then reconstructed to form the final LDR image. The transition images are processed based on the following equation (B):

$$\{ \begin{matrix}\begin{matrix}{m}_{n} = {m}_{low} \\ {m}_{l - 1} = {m}_{l}^{′} if 1 < l \leq n\end{matrix} \\ result = {m}_{high} + {m}_{1}\end{matrix} \qquad ( B )$$

In the above equation, m′ₗ is the up-sampled version of mₗ.

As can be seen, the first transition image m_{high} and the final transition image mₗ are combined to produce the final low dynamic range image.

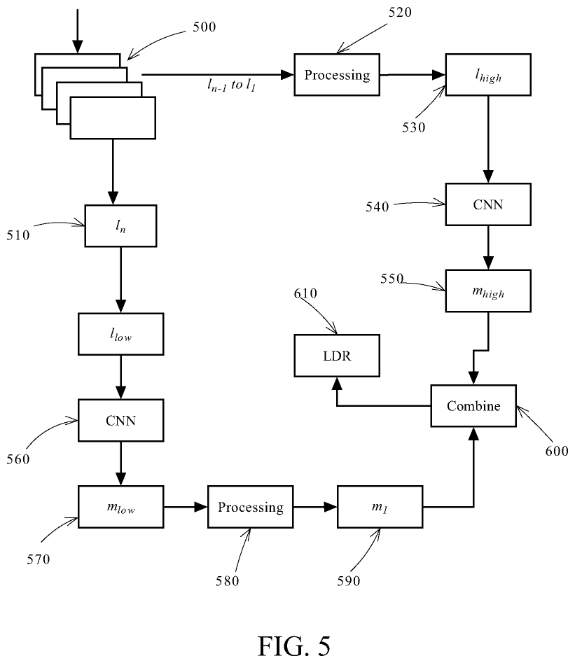

Schematically, this aspect of the present invention can be illustrated as shown in FIG. 5. Referring to FIG. 5, the process starts with a Laplacian decomposition of the original WDR image to produce decomposed images 500. This produces a last decomposed image in 510 which is segregated while the rest of the decomposed images are processed in box 520. Processing in box 520 follows equation (A) above and produces high frequency image l_{high} 530. This high frequency image 530 is then processed by a neural network 540 to produce a first transition image m_{high} 550.

On the other branch of the process, the last decomposed image in 510 can be renamed to how and is processed by the neural network 560. This processing produces a second transition image m_{low} 570. This second transition image is then processed by processing block 580 to produce the final transition image mₗ 590.

After the above, the final transition image and the first transition image are combined in a processing block 600 to produce the low dynamic range image 610. For clarity, the transition images for this aspect of the invention are obtained using the same process for obtaining the transition images in the first embodiment of the invention as explained in detail above. To reiterate, the neural networks that produce the transition images perform steps that detect large gradients from input data, compress detected large gradients, enhance small gradients, and reconstruct a transition image from the gradients.

As noted above, the above aspect of the invention can be implemented using software modules and only using two neural networks instead of n neural networks should reduce the computational and hardware needs of the invention. The processing blocks in the process usually involves up-sampling adjacent images.

For a better understanding of the various aspects of the present invention, the following references may be consulted. It should be clear that all of the following references are hereby incorporated in their entirety by reference.

[1] F. Drago, K. Myszkowski, N. Chiba, and T. Annen, “Adaptive logarithmic mapping for displaying high contrast scenes”, Computer Graphics Forum, vol. 22, no. 3, pp. 419-426, 2003.

[2] Reinhard, Erik, et al. “Photographic tone reproduction for digital images.” ACM transactions on graphics (TOG) 21.3 (2002): 267-276.

[3] E. Reinhard and K. Devlin, “Dynamic range reduction inspired by photoreceptor physiology”, IEEE Transactions on Visualization and Computer Graphics, vol. 11, no. 1, pp. 13-24, 2005.

[4] J. Van Hateren, “Encoding of high dynamic range video with a model of human cones,” ACM Transactions on Graphics (TOG), vol. 25, no. 4, pp. 1380-1399, 2006.

[5] H. Spitzer, Y. Karasik, and S. Einav, “Biological gain control for high dynamic range compression,” in Color and Imaging Conference, vol. 2003, pp. 42-50, Society for Imaging Science and Technology, 2003.

[6] R. Mantiuk, S. Daly, and L. Kerofsky, “Display adaptive tone mapping,” in ACM Transactions on Graphics (TOG), vol. 27, p. 68, ACM, 2008.

[7] K. Ma, H. Yeganeh, K. Zeng, and Z. Wang, “High dynamic range image tone mapping by optimizing tone mapped image quality index,” in 2014 IEEE International Conference on Multimedia and Expo (ICME), pp. 1-6, IEEE, 2014.

[8] F. Durand and J. Dorsey, “Fast bilateral filtering for the display of high-dynamic-range images,” in ACM transactions on graphics (TOG), vol. 21, pp. 257-266, ACM, 2002.

[9] K. He, J. Sun, and X. Tang, “Guided image filtering,” in European conference on computer vision, pp. 1-14, Springer, 2010.

[10] B. Gu, W. Li, M. Zhu, and M. Wang, “Local edge-preserving multiscale decomposition for high dynamic range image tone mapping,” IEEE Transactions on image Processing, vol. 22, no. 1, pp. 70-79, 2013.

[11] Z. Farbman, R. Fattal, D. Lischinski, and R. Szeliski, “Edge-preserving decompositions for multi-scale tone and detail manipulation,” in ACM Transactions on Graphics (TOG), vol. 27, p. 67, ACM, 2008.

[12] S. Paris, S. W. Hasinoff, and J. Kautz, “Local laplacian filters: edge aware image processing with a laplacian pyramid,” Communications of the ACM, vol. 58, no. 3, pp. 81-91, 2015.

[13] K. He, J. Sun, and X. Tang, “Guided image filtering,” in European conference on computer vision, pp. 1-14, Springer, 2010.

[14] Dong, Chao, et al. “Learning a deep convolutional network for image super-resolution.” European Conference on Computer Vision. Springer International Publishing, 2014.

[15] Xu L, Ren JS, Yan Q, Liao R, Jia J. Deep Edge-Aware Filters. InICML 2015 (pp. 1669-1678).

[16] Li, Yijun, et al. “Deep joint image filtering.” European Conference on Computer Vision. Springer International Publishing, 2016.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object-oriented language (e.g.“C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

1. A method for producing a low dynamic range image from a wide dynamic range image, the method comprising:
a) producing a normalized image of said wide dynamic range image;
b) decomposing said normalized image into multiple Laplacian images;
c) passing each of said multiple Laplacian images through a different level of sets of processing layers, each level of sets of processing layers producing a transition image to result in a plurality of transition images;
d) reconstructing a coarse low dynamic range image from said plurality of transition images;
e) generating a final low dynamic range image from said coarse low dynamic range image;
wherein each level of sets of processing layers comprises multiple layers of processing layers.

2. The method according to claim 1, wherein each level of sets of processing layers comprises a neural network.

3. The method according to claim 2, wherein each processing layer of each level comprises a plurality of kernels, each kernel being for performing a function specific to said processing layer.

4. The method according to claim 2, wherein said neural network is trained using a user selected training set of input training wide dynamic range images and corresponding output training low dynamic range images.

5. The method according to claim 2, wherein a loss function used for training said neural network comprises either a perceptual loss function or a Mean Square Error (MSE) loss function, said loss function being between an input image and an output image from a training set.

6. The method according to claim 5, wherein said MSE loss function comprises:
$${l}_{per \text{-} pixel} ( \hat{y} , y ) = \frac{1}{CHW} ‖ \hat{y} , y ‖$$
where C, H, W are the shapes of ŷ and y and where, during training, ŷ is an output of a transform network and where y is a ground truth image M′{i}.

7. The method according to claim 5, wherein said perceptual loss function comprises:
$${loss}_{∅ , j} ( \hat{y} , y ) = \frac{1}{{C}_{j} \times {H}_{j} \times {W}_{j}} ‖ {∅}_{j} ( \hat{y} ) - {∅}_{j} ( y ) ‖$$
where ∅ⱼ(x) is an activation of a j-th layer of a neural network ∅ when processing input x and where Cⱼ, Hⱼ, Wⱼ are shapes of ∅ⱼ(x) and where ŷ is an output of a neural network and where y is an expected ground truth.

8. A system for producing a low dynamic range image from a wide dynamic range image, the system comprising:
at least one data processor configured for:
producing a normalized image of said wide dynamic range image;
decomposing said normalized image into multiple Laplacian images;
passing each of said Laplacian images through a different level of sets of processing layers, each level of sets of processing layers producing a transition image;
combining transition images produced by each level of sets of processing layers to produce said low dynamic range image;
and
a database of training wide dynamic range images and corresponding training low dynamic range images, said training wide dynamic range images and corresponding training low dynamic range images being for use in determining parameters for said levels of sets of processing layers;
wherein
each level of sets of processing layers is implemented as processor readable and executable instructions for:
detecting large gradients from input data;
compressing detected large gradients and enhancing small gradients; and
reconstructing a transition image from said gradients.

9. The system according to claim 8, wherein each of said levels of sets of processing layers is implemented as at least one neural network.

10. (canceled)

11. A method for processing a wide dynamic range image to result in a low dynamic range image, the method comprising:
a) producing a normalized image from said wide dynamic range image and decomposing said normalized image into multiple Laplacian images;
b) processing each of said multiple Laplacian images to detect large gradients from input data;
c) processing a result of step b) to compress large gradients and to enhance small gradients;
d) processing a result of step c) to reconstruct a transition image;
wherein said transition image is used to construct said low dynamic range image and at least one of steps b)-d) is accomplished by way of a convolutional neural network.

12. The method according to claim 11, wherein each Laplacian image is processed by said convolutional neural network implementing steps b)-d) using a plurality of kernels, each kernel being for performing a function specific to at least one of said steps b)-d).

13. The method according to claim 11, wherein said convolutional neural network is trained using a user selected training set of input training wide dynamic range images and corresponding output training low dynamic range images.

14. The method according to claim 11, wherein a loss function used for training said neural network comprises a Mean Square Error between an input image and an output image from a training set.

15. A method for processing a wide dynamic range image to result in a low dynamic range image, the method comprising:
a) producing a normalized image from said wide dynamic range image and decomposing said normalized image into n multiple Laplacian images, said multiple Laplacian images including a last decomposed image layer lₙ;
b) except for said last decomposed image layer, processing each of said multiple Laplacian images to produce a high frequency image l_{high} containing high frequency signals of said wide dynamic range image;
c) processing said high frequency image using a neural network to produce a first transition image m_{high};
d) processing said last decomposed image layer using a neural network to produce a second transition image m_{low};
e) processing said second transition image to produce a final transition image m₁;
f) combining said first transition image and said final transition image to produce said low dynamic range image.

16. The method according to claim 15, wherein said last decomposed image layer has a resolution that is
$$\frac{1}{{2}^{n - 1}}$$
of a resolution of said wide dynamic range image.

17. The method according to claim 15, wherein step b) comprises processing each of said multiple Laplacian images using
$$\{ \begin{matrix}{g}_{n - 1} = {l}_{n - 1} \\ {g}_{k} = {l}_{k} + {g}_{k + 1}^{′} if 0 < k < n - 1\end{matrix}$$
wherein lₙ₋₁ to b are said multiple Laplacian images and said l_{high} is equal to g₁ and where g′ₖ₊₁ is an up-sampled version of gₖ₊₁.

18. The method according to claim 15, wherein step e) comprises processing said second transition image according to:
$$\begin{matrix}{m}_{n} = {m}_{low} \\ {m}_{l - 1} = {m}_{l}^{′} if 1 < l \leq n\end{matrix}$$
wherein m is an up-sampled version of m₁.

19. The method according to claim 15, wherein said transition images are produced by said neural networks from said images by
detecting large gradients from input data;
compressing detected large gradients and enhancing small gradients; and
reconstructing a transition image from said gradients.
